(19) United States
(12) Patent Application Publication
(10) Pub. No.: US 2008/0104847 A1
(43) Pub. Date: May 8, 2008

(54) Curved razor and method

(76) Inventors: Richard Veras, Theils, NY (US); Salvatore Celeste, Peabody, MA (US)

Correspondence Address: Eugene Lieberstein, 2151 Long Ridge Road, Stamford, CT, 06903, US

(21) Appl. No.: 11/418,241

(22) Filed: May 5, 2006

(51) Int. Cl. B26B 21/06; B21K 11/00; B26B 21/52; B26B 21/00

(52) U.S. Cl. 30/49; 76/104.1

(57) ABSTRACT

A safety razor and method of manufacturing a safety razor comprising molding a razor head and a razor blade in a curvilinear mold with the razor blade captured in the razor head such that both the head and blade form a single unitary body with each having a common fixed curvilinear geometry and a handle for the razor adjustably connected to the head such that the curved razor blade may be adjustably positioned relative to the handle to orient the razor blade into one of two opposite directions for use by either a right handed or left handed person.

### FIELD OF THE INVENTION

This invention relates to a curved razor and method wherein the razor head and razor blade are integrally formed in a curvilinear mold to produce a unitary molded body in which the razor blade extends from the body in a fixed curvilinear geometry.

### BACKGROUND OF THE INVENTION

It is difficult for a professional barber or hair stylist to accurately style the scalp to provide a curved hair line using a straight edged razor. Alternatively, it is relatively easy to curve the hair line on the scalp into any desired curvature or to form sharp curved edges using a curved razor blade. Interestingly, it has been discovered that a curved razor can also be used at the center of curvature as a substitute for a straight razor to shave straight edge surfaces as well as to trim off an edge with the same accuracy as a straight razor. A curved razor would fill a need of the professional barber as a substitute for a straight razor for styling hair along the edge of the scalp provided the curved razor was easy to use, relatively inexpensive and preferably dispensable. Moreover, the razor, if it has a curved geometry, should be adjustable for use in either the left or right hand to provide additional control and to permit usage by either a left handed or right handed person.

It has been discovered in accordance with the present invention that an inexpensive curved razor having a fixed curvature can be formed by molding the head of the razor with the razor blade captured in the head using a curvilinear mold so that the razor head and razor blade form a single unitary body with each having a common fixed curvilinear geometry. The razor head may be composed of any conventional plastic composition with the razor blade preferably of metal. It has been further discovered that by molding the head of the razor and the razor blade to form a unitary curved body the head of the curved razor can be easily connected to a handle to readily permit adjustment of the curved razor blade relative to the handle into one of two opposite directions for use by either a right handed or left handed person.

### SUMMARY OF THE INVENTION

A safety razor comprising a razor head and razor blade molded into a single unitary body with the razor blade and razor head of fixed curvilinear geometry and a handle extending from the razor head with the razor head being adjustably connected to said handle such that said curved razor blade is movably adjusted relative to the handle to orient the razor blade into one of two opposite directions for use by either a right handed or left handed person.

A safety razor is formed in accordance with the method of the present invention to provide a curved razor blade having a fixed curvature by molding the head of the razor in a curvilinear mold with the razor blade captured in the head so that the razor head and razor blade form a single unitary body with each having a common fixed curvilinear geometry.

### BRIEF DESCRIPTION OF THE DRAWINGS

Additional advantages of the present invention will become apparent from the following detailed description of the invention when read in conjunction with the accompanying drawings of which:

FIG. 1 is a side elevation of the safety razor of the present invention with the razor blade shown protected by a removable shield;

FIG. 2 is a side elevation of the safety razor of the present invention similar to FIG. 1 without the removable shield;

FIG. 3 is an enlarged view in cross section of the top half of the safety razor of FIG. 1 taken along the lines 3-3 of FIG. 1;

FIG. 4 is a partial view of the razor head in the safety razor of FIG. 3 at the adjustable point of connection to the handle;

FIG. 5 is a view in cross section taken along the lines 5-5 in FIG. 3 representing the line of curvature of the razor head;

FIG. 6 is a view taken along the lines 6-6 in FIG. 5;

FIG. 7 is an exploded diagrammatic view of the safety razor of FIG. 1;

FIG. 8 is a front elevation of the safety razor of FIG. 1 showing the razor head being turned from one position to another; and

FIG. 9 is another side elevation of the safety razor of the present invention with the razor blade oriented into a position opposite to the position of FIG. 1.

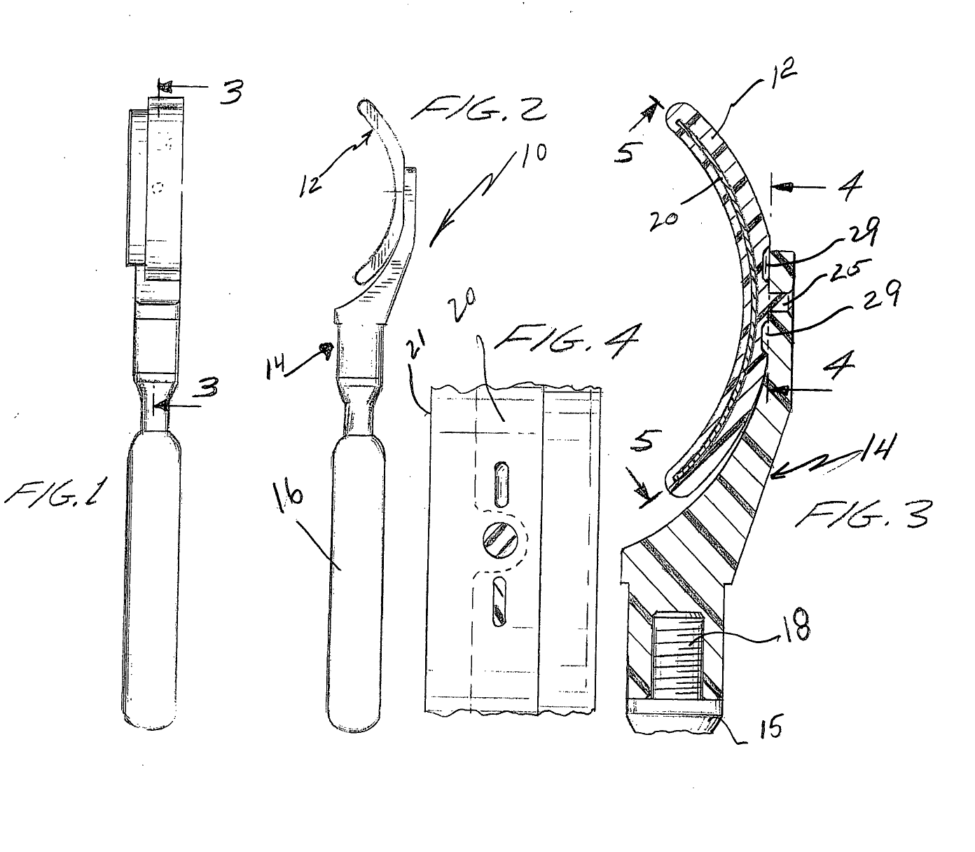

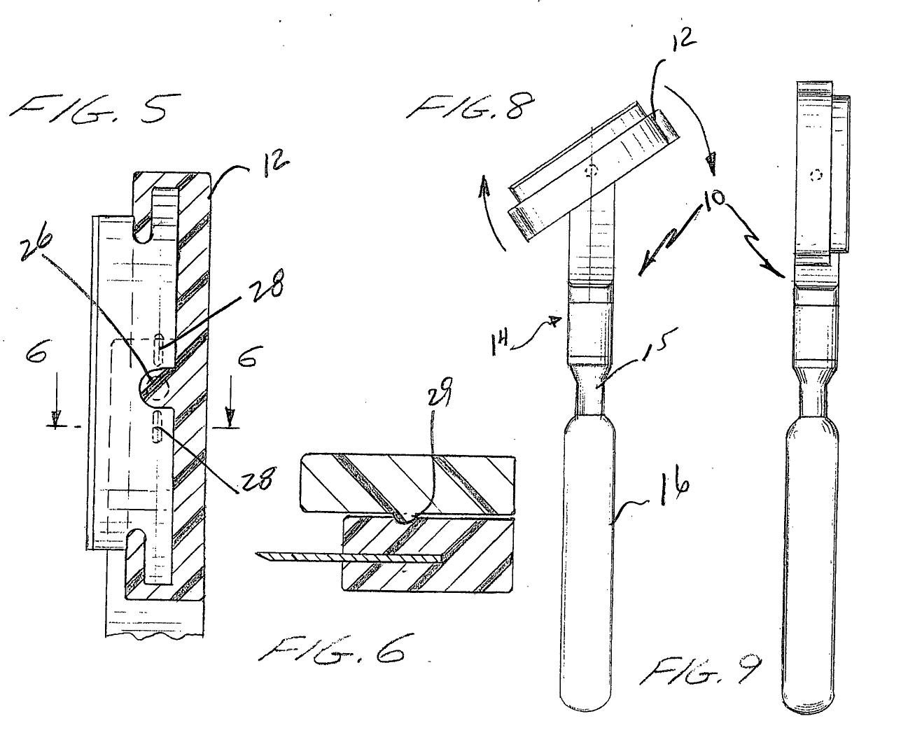

### DETAILED DESCRIPTION OF THE INVENTION

Referring in detail to the drawings in which a safety razor 10 is shown comprising a head 12 and a handle 14 with the head 12 being adjustably connected to the handle 14. The handle 14 may be a single elongated component or may be composed of two removably interconnected parts 15 and 16 in which the bottom part 15 of the handle 14 has a threaded head 17 and the top part of the handle 14 has a matching threaded bore 18 for receiving the head 17.

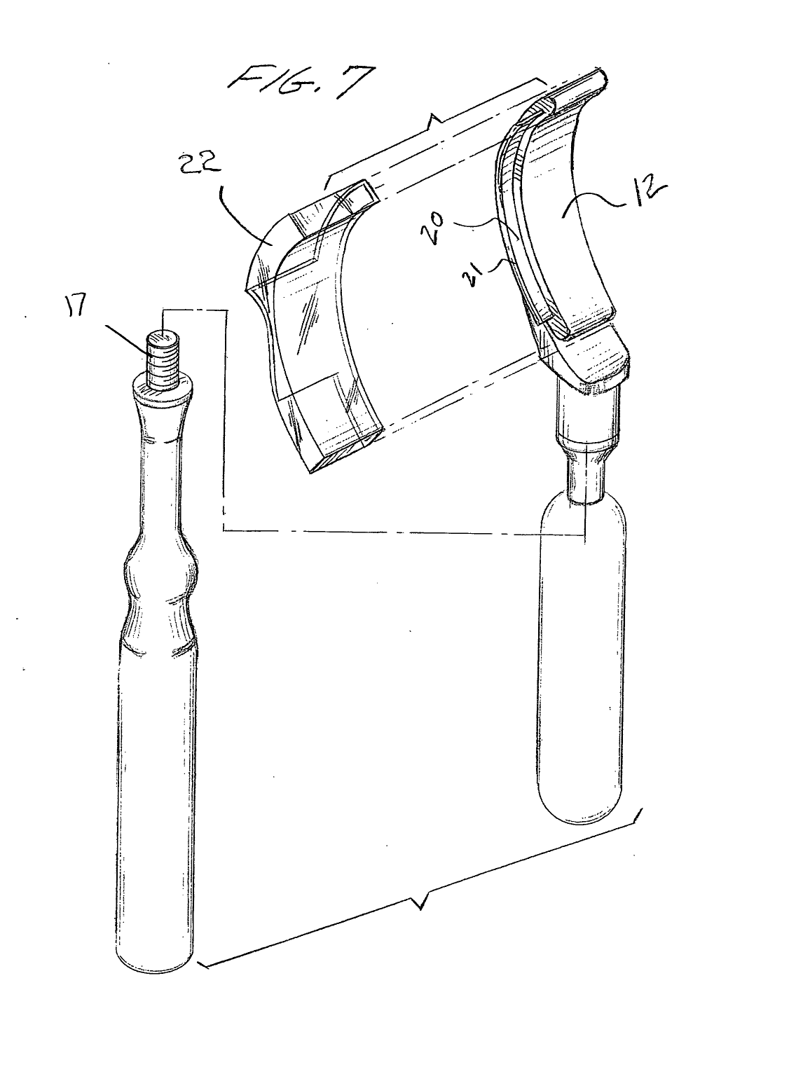

The head 12 of the razor 10 includes a razor blade 20 which is captured in the head 12 during molding using a mold having a curvilinear geometry so that the head 12 and blade 20 have a fixed curvature with a preferably sharpened edge 21 of the razor blade 20 extending from the head 12. The head 12 may be composed of any conventional material composition preferably plastic whereas the razor blade 20 is preferably of metal. A removable shield 22, as more clearly shown in FIG. 7, covers the razor blade 20 and one side of the head 12 for protecting a person from being cut by the razor blade 20 during transportation and when the safety razor 10 is not intended to be used.

The head 12 of the razor 10 has a projection 25 which removably fits into a hole or detent 26 in the handle 14 to permit the head 12 to be rotated relative to the handle 14 for orienting the blade 20 to face the opposite direction so that the safety razor 10 may be used by a left or right handed person. The handle 14 also preferably includes one or two recesses 28 on opposite sides of the projection 25 with complementary protrusions 29 extending from the surface of the handle 14 opposite the recesses 28 to lock the head 12 into one of two positions in the handle 14 with the blade oriented such that the shaving edge 21 faces either to the left or right side when the handle held in a vertical position.

What is claimed:

1- A safety razor comprising a razor head and razor blade integrally configured in a single unitary body with the razor blade extending from the razor head and with both the razor blade and razor head having a fixed curvilinear geometry and a handle extending from the razor head with the razor head being adjustably connected to said handle such that said curved razor blade is adjustably positioned relative to the handle to orient the razor blade into one of two opposite directions for use by either a right handed or left handed person respectively.

2- A safety razor as defined in claim 1 wherein said head is rotatably mounted in said handle at one end thereof to orient the razor blade into said one of two opposite directions.

3- A safety razor as defined in claim 2 wherein said head has a projection extending from one side thereof and said handle has an opening for receiving said projection to enable said razor blade to be oriented into said two directions opposite one another.

4- A safety razor as defined in claim 3 wherein said head has at least one recess adjacent said projection and said handle has a protrusion at on said handle complementary to the position of said recess for locking said safety razor into the adjusted position of the razor blade.

5- A method of manufacturing a safety razor with a curved razor blade comprising molding a razor head and a razor blade in a curvilinear mold with the razor blade captured in the razor head such that both the head and blade form a single unitary body with each having a common fixed curvilinear geometry.
